(19) United States
(12) Patent Application Publication
(10) Pub. No.: US 2007/0226740 A1
(43) Pub. Date: Sep. 27, 2007

(54) Method and apparatus for global breakpoint for parallel debugging on multiprocessor systems

(76) Inventors: Xiao-Feng Li, Beijing (CN); Dz-ching Ju, Saratoga, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/364,942

(22) Filed: Feb. 28, 2006

(51) Int. Cl. G06F 9/46

(52) U.S. Cl. 718/102

(57) ABSTRACT

A system that concurrently executes threads of a multi-threaded application pauses the execution of one thread, then pauses the execution of another thread before the second thread alters a shared memory state. Chipsets and software to implement embodiments of the invention are also described and claimed.

### FIELD

The invention relates to software debugging. More specifically, the invention relates to debugging multi-threaded applications running on multiprocessor systems.

### BACKGROUND

A traditional model of computer operation involves a single programmable processor executing a sequence of instructions contained in a memory to perform various operations on data. (In the taxonomy proposed by Michael Flynn in his 1972 paper, “Some Computer Organizations and Their Effectiveness,” IEEE Trans. Comput., Vol. C-21, pp. 94, this is a “single-instruction, single-data” or “SISD” model.) Debugging a SISD program is straightforward: one can set a breakpoint to stop the program if execution reaches a particular location, or if the program performs a particular operation, and examine the state of the program at that time.

However, many contemporary computer systems have multiple processors that can execute a corresponding number of instruction streams concurrently, operating on data that may be shared (“multiple-instruction, multiple-data” or “MIMD” systems). Concurrently-executing instruction sequences operating in a shared memory arena are commonly called “threads.” Debugging threaded programs may be more difficult because although a breakpoint can stop any particular thread at a selected instruction, other threads may continue to execute. If the other threads alter shared memory state, an engineer examining the memory contents may find inconsistent or confusing data. Even thread-aware debuggers that provide “global suspension” to stop related threads when one thread reaches a breakpoint cannot guarantee that the related threads will stop before altering shared memory.

Techniques to ensure memory state consistency when debugging threaded programs may be of value in this field.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a sequence of thread operations, including post-breakpoint operations that may result in inconsistent or confusing memory contents.

FIG. 2 shows a similar sequence of thread operations where global memory consistency has been maintained.

FIG. 3 is a flowchart of operations according to a software embodiment.

FIGS. 4A and 4B show some components of a hardware embodiment.

FIG. 5 is a flowchart of operations of a hardware embodiment.

### DETAILED DESCRIPTION

Embodiments of the invention use software and/or hardware techniques to ensure state consistency when debugging multi-threaded applications. When one thread reaches a breakpoint, it produces a signal that can be sensed by other threads. Other threads respond to the signal by stopping before they alter, or even before they access, shared memory.

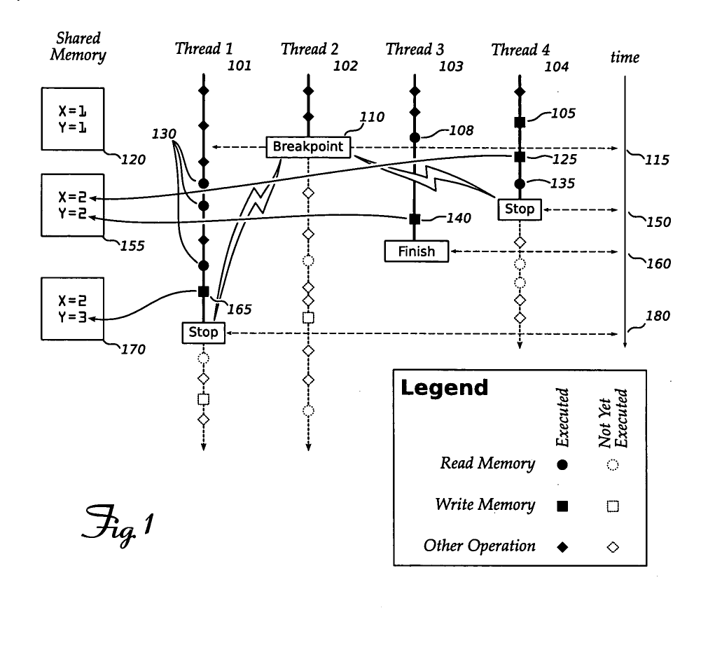

FIG. 1 shows how inconsistent memory contents can arise while debugging a threaded program. Threads 1 through 4 (101-104) are executing, and each may refer to information in shared memory (represented here as variables X and Y). Thread 2 102 encounters breakpoint 110 at time 115, when the shared memory contains values shown at element 120. The debugger signals the other threads in the program to stop (perhaps using a thread or process control facility provided by the operating system), but the other threads may not receive or respond to the signal until later, at times shown as 150 and 180. In this example, Thread 3 103 happens to finish executing at time 160, before (or instead of) stopping in response to the debugger's signal.

Threads 1, 3 and 4 may access or modify shared memory while they are executing. References and modifications that occur before breakpoint 110 (e.g. memory write 105 and memory read 108) do not change memory in a way that may be unexpected, but memory writes that occur after breakpoint 110 (time 115) (e.g. memory writes 125, 140 and 165) may change memory so that an engineer cannot determine what was the program's state at time 115. Memory reads 130 and 135, as well as “other operations,” (unlabeled), do not alter memory contents, and so may be permitted.

Note that the length of time between the breakpoint at 115 and all threads stopping at 180 may be quite short—perhaps on the order of tenths or hundredths of milliseconds—but modern processors can execute millions of instructions in that short time, so there is ample opportunity for confusing memory changes to occur.

An embodiment of the invention can improve on the situation shown in FIG. 1 and ensure that the other threads stop before altering shared memory, or even before accessing shared memory, if desired. The method described is a good compromise between stopping “pretty soon,” as shown in FIG. 1, and checking for stopped sibling threads before each operation (an approach that would slow the program inordinately).

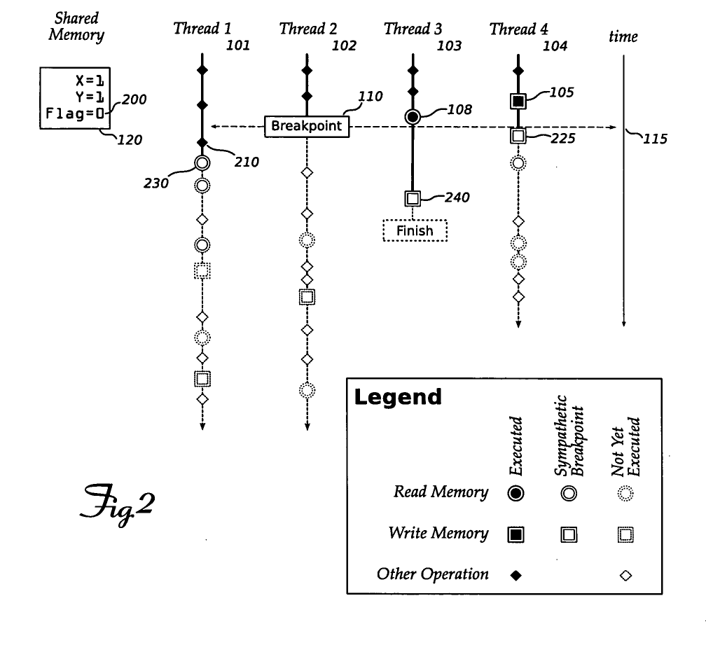

FIG. 2 shows the same four threads from FIG. 1, but each memory write operation and memory read operation has been instrumented as described below (the instrumentation is indicated in this figure by a circle or square around the operation symbol).

As before, thread 2 102 encounters breakpoint 110 at time 115. Processing in the thread context or in the debugger sets breakpoint flag 200 in the shared memory. When threads 1 101, 3 103 and 4 104 execute the next instrumented memory read or write within their respective instruction sequences, the instrumentation code detects the set breakpoint flag and stops the thread before the read or write is performed. These are shown as “sympathetic breakpoints” 225, 230 and 240.

Sibling threads may execute for some time after breakpoint 110 is encountered at time 115 (in this example, thread 1 101 performs “other operation” 210) but because memory writes and, optionally, memory reads are instrumented, memory state 120 will not be changed after time 115 and the debugging work may be simplified.

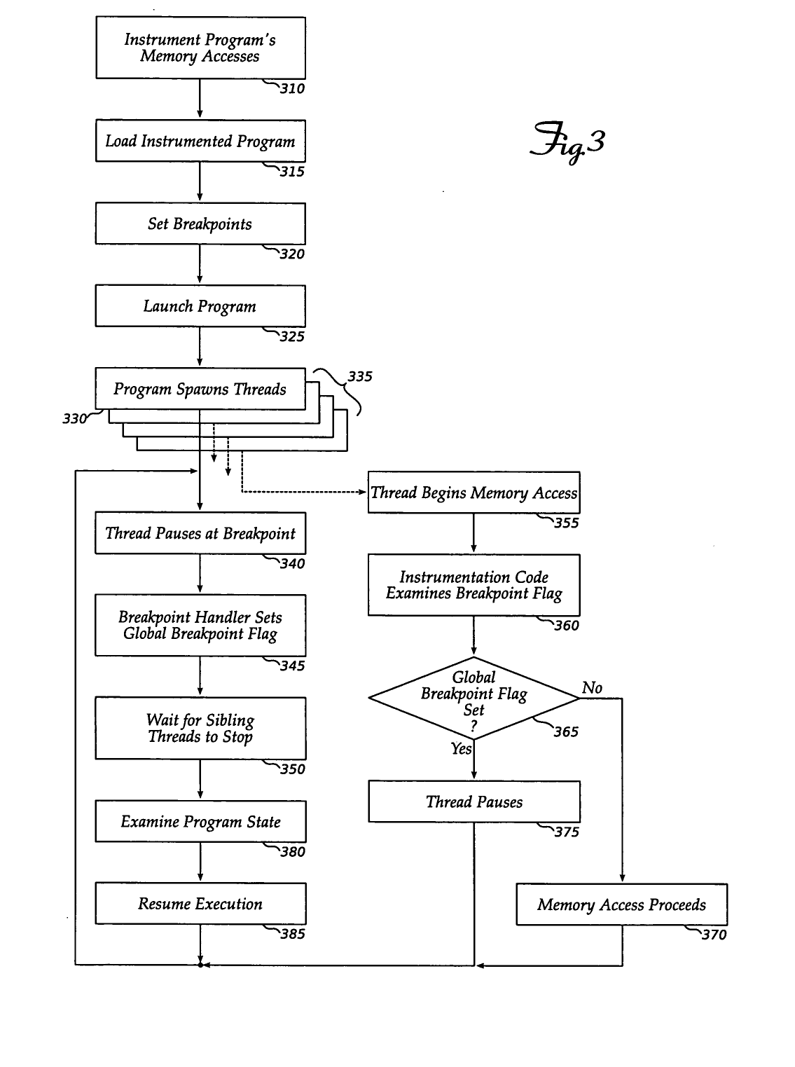

FIG. 3 is a flowchart showing a process of instrumenting and then debugging a multi-threaded program according to an embodiment of the invention. First, the program's memory access instructions are identified and instrumented with additional code to implement the sympathetic breakpoint function (310). The instrumentation may be performed by a compiler when the program is being converted from source code into an executable image, or by a debugger prior to executing the program. An advantage of instrumenting a program with a compiler is that the compiler may have access to additional information about various memory operations, and may be able to distinguish between accesses of local memory and shared memory. To ensure a consistent global state, only write accesses to shared memory need be instrumented, but less sophisticated embodiments (or embodiments where the instrumenting entity cannot distinguish between local and shared memory accesses) may instrument all memory accesses. Next, a debugger or other runtime environment loads the instrumented program into memory in preparation for execution (315). Breakpoints may be set at this time (320), then the program is launched (325).

A breakpoint is a generic term for a facility that can interrupt or pause the execution of a thread if certain conditions arise. The simplest sort of breakpoint causes the thread to stop if execution reaches a particular instruction. Other types of breakpoints can cause the program to stop if an instruction reads a particular memory location, or if an instruction attempts to alter the contents of a memory location. Some debugging environments provide additional controls, so that a breakpoint is only triggered on the second (or other subsequent) occurrence of an event, only if a particular value is stored in a memory location, or only upon the occurrence of another combination of conditions.

After the program is launched, it may spawn several threads to perform various tasks (330). These “sibling” threads 335 execute concurrently with each other and with the first thread, and share at least a portion of their memory spaces.

When one of the threads pauses at a breakpoint (340), a breakpoint handler sets a global breakpoint flag (345). Since multiple breakpoints may have been set in the various threads, writes to the global breakpoint flag should be protected by synchronization code. The debugging environment may wait for some or all sibling threads to stop before permitting the user to examine the execution environment (350).

In the meanwhile, another thread may begin a memory access (355). If the access is instrumented, the instrumentation code will examine the breakpoint flag (360), and if it is set (365), this thread will pause as well (375). If the flag is clear, the memory access proceeds as usual (370).

Once some or all of the sibling threads have stopped, the debugger permits the user to examine the program state (380). In some cases, the user may also be permitted to modify the program state (for example, to test the program's response to a specific set of conditions). Finally, the debugger un-pauses the threads and execution resumes (385).

By operating a program within a debugging environment as described above, one can ensure that a multi-threaded program's global state is consistent when a breakpoint is recognized and thus avoid some confusion and wasted effort during software development and debugging. However, instrumenting a program may increase its size or alter its execution patterns, thereby changing its behavior. In some embodiments, hardware facilities of a system may be employed instead of instrumentation to achieve the same consistent shared memory state during debugging.

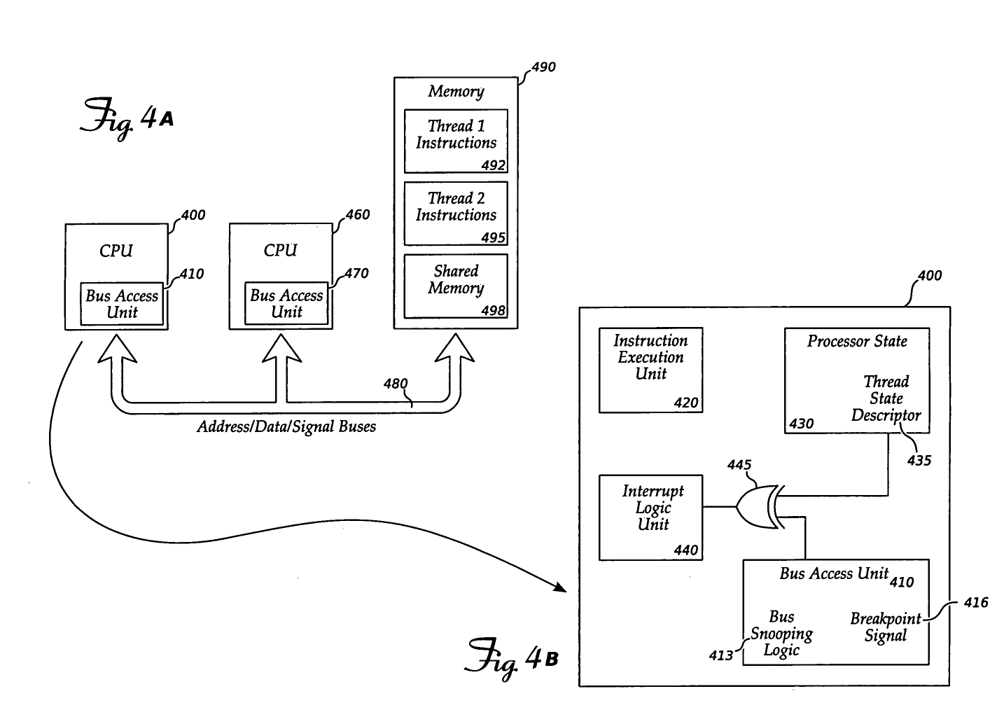

FIG. 4A shows some components of a computer system that can implement an embodiment of the invention. This system has two separate central processing units (“CPUs,” also called “processors”) 400 and 460, including a bus access unit 410, 470 for exchanging addresses, data, and signals with various system buses 480. Also depicted is memory 490, which may contain instructions for thread 1 492 and thread 2 495, as well as an area 498 that is shared between the threads.

FIG. 4B shows several logical components that may be found within a CPU in a system. Instruction execution unit 420 executes program instructions fetched from system memory by bus access unit 410. Information necessary for the proper execution of program instructions may be stored in processor state memory 430; one portion of the processor state may include information about a thread whose instructions the processor is currently executing (thread state descriptor 435). Bus access unit 410 may include breakpoint signal logic 416 to signal other processors and system components if a thread whose instructions the processor is executing reaches a breakpoint, and bus snooping logic 413 to detect such signals from other processors. The signal may be a special type of bus cycle executed by the bus access unit 410 or a separate signal (possibly multiplexed with other signals). Breakpoint bus cycles may have higher priority than other types of bus cycles, so that a breakpoint notification can pre-empt bus activity of other processors (including, particularly, write cycles that may result in another processor altering the contents of shared memory). Bus snooping logic 413 can detect the special bus cycle or signal.

A processor may include an interrupt logic unit 440 to manage various interrupt sources, including thread breakpoint logic 445, which may provide an interrupt if bus snooping logic detects a breakpoint signal from another processor that is executing a thread related to the thread currently executing in processor 400. (Some embodiments may omit this comparison logic and simply interrupt the processor if any other processor signals that it has reached a breakpoint).

Processors in a system according to an embodiment of the invention may be physically separate units, or may be sub-components of multi-processor packages. Some processors may include multiple “execution cores,” or instruction execution units and associated logic and state information, which may share other support and/or control logic. Systems containing processors, CPUs, and/or execution cores that can concurrently execute instructions from a plurality of instruction sequences may benefit from embodiments of the invention. This sort of concurrent execution should be distinguished from pseudo-concurrency that may be simulated on a uniprocessor system through techniques such as time-slicing.

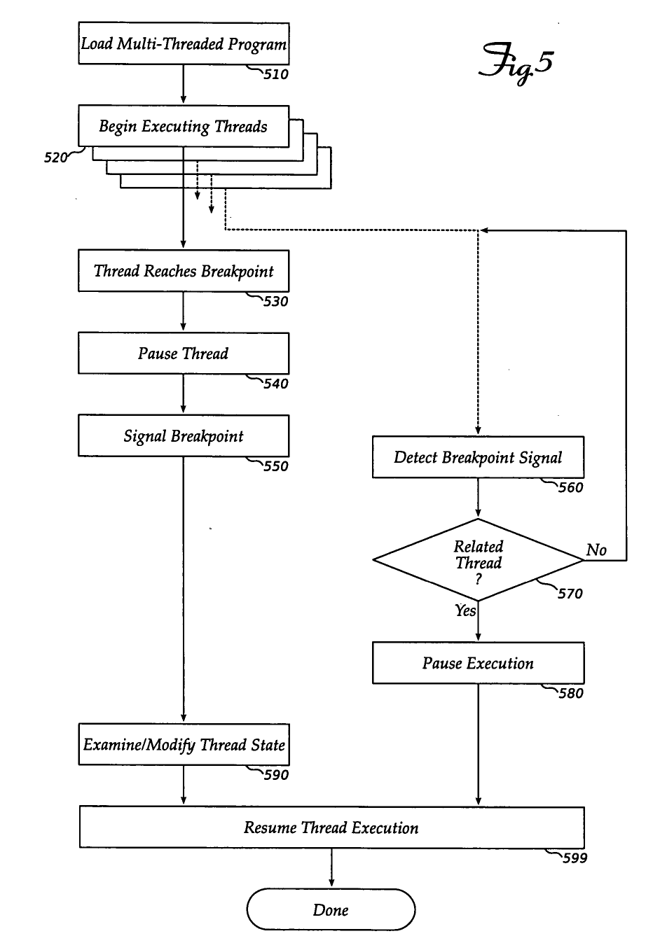

A system including the hardware support structures shown in FIG. 4 can operate to ensure consistent memory state when debugging multi-threaded programs without requiring the program instrumentation described above. This operation is shown in FIG. 5.

A multi-threaded program is loaded into memory (510) and the processors begin executing its threads (520). If there are more threads than processors, some of the threads may be time-sliced, but at least some instructions of some threads are executed concurrently on different processors or execution cores.

When one thread reaches a breakpoint (530), the system pauses its execution (540) and signals that a thread breakpoint has occurred (550). The signal may be a hardware signal, breakpoint bus cycle, or similar mechanism, as discussed above. The bus snooping logic on other processors in the system detects the breakpoint signal (560) and pauses the execution of thread instructions on those processors (580). In some embodiments, thread breakpoint logic may compare an identity of the thread that reached a breakpoint to the identity of a thread executing on the processor, and only pause instruction execution if the threads are related (570). Debugging system logic permits the user to examine and/or modify the thread state (590), then execution may be resumed (599).

An embodiment of the invention may be a machine-readable medium having stored thereon instructions which cause a processor to perform operations as described above. For example, an embodiment of the invention may be implemented in a compiler to translate source code into executable machine instructions; the embodiment could instrument global (or all) memory writes (or all accesses). Another embodiment in the form of a machine-readable medium may be a debugging environment to instrument pre-compiled code before executing it.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over the Internet.

The applications of the present invention have been described largely by reference to specific examples and in terms of particular allocations of functionality to certain hardware and/or software components. However, those of skill in the art will recognize that consistent thread global state for simpler debugging can also be achieved by software and hardware that distribute the functions of embodiments of this invention differently than herein described. Such variations and implementations are understood to be captured according to the following claims.

We claim:

1. A method comprising:
concurrently executing a plurality of threads of a multi-threaded program;
pausing an execution of a first thread of the plurality of threads; and
pausing an execution of a second thread of the plurality of threads after pausing the execution of the first thread and before the second thread alters a shared memory state.

2. The method of claim 1, further comprising:
indicating that the execution of the first thread has been paused.

3. The method of claim 2 wherein indicating comprises storing a value in a shared memory location.

4. The method of claim 2 wherein indicating comprises raising a hardware signal.

5. The method of claim 2 wherein indicating comprises performing a breakpoint bus cycle.

6. The method of claim 1, further comprising:
pausing the execution of the second thread before the second thread accesses a shared memory location.

7. The method of claim 1, further comprising:
checking a state of a global variable before a memory access by a thread; and
if the state of the global variable matches a predetermined state, pausing the execution of the thread.

8. The method of claim 1 wherein pausing the execution of the first thread occurs if the first thread:
executes a predetermined instruction;
accesses a predetermined memory location; or
alters a content of a predetermined memory location.

9. A chipset comprising:
a plurality of processor cores, each core to execute instructions in a memory;
a breakpoint signal to indicate if a first processor core reaches a breakpoint;
snooping logic to detect the breakpoint signal; and
interrupt logic to change an execution context of a second processor core if the snooping logic detects the breakpoint signal.

10. The chipset of claim 9, further comprising:
a thread state descriptor to identify a thread being executed by a processor core, wherein
the interrupt logic is to change the execution context of the processor core only if the processor core is executing instructions from a second thread related to a first thread that reached the breakpoint.

11. The chipset of claim 9, further comprising:
a bus access unit to mediate use of a bus by the plurality of processor cores, wherein
the breakpoint signal comprises a bus transaction that has a higher priority than any other memory access bus transactions.

12. The chipset of claim 9 wherein the breakpoint signal comprises a signal on a dedicated pin.

13. A machine-readable medium containing instructions that, when executed by a programmable processor, cause the processor to perform operations comprising:
identifying, in an instruction sequence, an instruction that is to access memory; and
instrumenting the instruction to examine a global indicator before accessing the memory, wherein
if the global indicator signals a breakpoint, the memory access is postponed.

14. The machine-readable medium of claim 13 wherein the instruction that is to access memory is a “write” instruction.

15. The machine-readable medium of claim 13 wherein the memory that is to be accessed by the instruction is a shared memory.

16. A system comprising:
a memory to contain instructions for a plurality of threads;
a plurality of processor cores to execute instructions in the memory;
a debugging environment to set a breakpoint if an instruction attempts to alter a content of a memory location; and
a chipset to issue a breakpoint signal if a first processor core executes an instruction that attempts to alter the content of the memory location and to interrupt a second processor if the breakpoint signal is issued.

17. The system of claim 16, further comprising:
comparison logic to compare an identity of a thread executing on the first processor to an identity of a thread executing on the second processor.

18. The system of claim 16 wherein a number of threads in the plurality of threads exceeds a number of processor cores in the plurality of processor cores, the system further comprising:
logic to time-slice execution of instructions of at least two threads on one of the plurality of processor cores.
